(19) United States
(12) Patent Application Publication
(10) Pub. No.: US 2024/0211823 A1
(43) Pub. Date: Jun. 27, 2024

(54) OPERATION CONTENT PRESENTATION METHOD, OPERATION CONTENT PRESENTATION DEVICE, AND OPERATION CONTENT PRESENTATION SYSTEM

(71) Applicant: Hitachi, Ltd., Tokyo (JP)

(72) Inventors: Jun KITAWAKI, Tokyo (JP); Takashi TAMESHIGE, Tokyo (JP)

(21) Appl. No.: 18/235,969

(22) Filed: Aug. 21, 2023

(30) Foreign Application Priority Data
Dec. 27, 2022 (JP) 2022-209531

(51) Int. Cl. G06Q 10/063

(52) U.S. Cl. CPC G06Q 10/063

(57) ABSTRACT

A technique of providing operation information on the same failure and management operation to an IT-service providing system of a different configuration is provided. The operation information can be shared among a plurality of environments and thus the operation cost can be reduced. An operation content presentation device has a storage device that stores a software mapping table storing information on software used by each of organizations, an operation mapping table storing information on an operation of a same content for a predetermined operation, and an operation target table listing operation targets of the respective organizations. The processor performs commonization of an operation content corresponding to a response content among the organizations, using each of these tables, and outputs, using a response content of one of the organizations as an input, an operation content of another one of the organizations similar to the operation content corresponding to the response content.

### CROSS-REFERENCE TO RELATED APPLICATION

The present application claims priority from Japanese application JP2022-209531, filed on Dec. 27, 2022, the content of which is hereby incorporated by reference into this application.

### TECHNICAL FIELD

The present invention relates to an operation content presentation method, an operation content presentation device, and an operation content presentation system.

### BACKGROUND ART

As a result of widespread use of public cloud and promotion of digital transformation (DX), systems that used to be established in a corporate network and provided Internet technology (IT) services have recently been migrated onto the public cloud and operated. Since the corporate network and the public cloud are different from each other in operations management method, companies are accumulating knowledge for such operations. The operation regarding a service provided on the public cloud and a plurality of corporate networks varies among different environments. This means that an operation proven effective in one environment is not necessarily usable directly in other environments. This is expected to be the reason why the operations have not been shared.

PTL 1 discloses a technique of presenting an operation of identifying a failure that has occurred and an operation for recovery, using a history of commands executed on a single host in the past and information on software installed.

### CITATION LIST

### Patent Literature

PTL 1: JP2016-162282A

### SUMMARY OF INVENTION

### Technical Problem

Unfortunately, with PTL 1, while an operation on a single host can be presented, an operation should not be presentable for exactly the same failure occurring on another host. Furthermore, the technique does not cover an IT service system including a plurality of hosts, and an environment with a different configuration of software installed.

In view of the above, an object is to provide a technique of providing operation information on the same failure and management operation to an IT-service providing system of a different configuration, so that the operation information can be shared among a plurality of environments and thus the operation cost can be reduced.

### Solution to Problem

One aspect of the present disclosure is the following operation content presentation method. The operation content presentation method is a method performed using a processor, a storage device, and a display device. The storage device stores a software mapping table storing information on software used by each of organizations, an operation mapping table storing information on an operation of a same content for a predetermined operation, and an operation target table listing operation targets of the respective organizations. The processor performs commonization of an operation content corresponding to a response content among the organizations, using the software mapping table, the operation mapping table, and the operation target table, and the processor makes the display device display, using a response content of a predetermined one of the organizations as an input, an operation content of another one of the organizations similar to the operation content corresponding to the response content.

One aspect of the present disclosure is the following operation content presentation device. The operation content presentation device includes a processor and a storage device. The storage device stores a software mapping table storing information on software used by each of organizations, an operation mapping table storing information on an operation of a same content for a predetermined operation, and an operation target table listing operation targets of the respective organizations. The processor performs commonization of an operation content corresponding to a response content among the organizations, using the software mapping table, the operation mapping table, and the operation target table, and outputs, using a response content of a predetermined one of the organizations as an input, an operation content of another one of the organizations similar to the operation content corresponding to the response content. Also provided is an operation content presentation system including the operation content presentation device and a terminal to which the operation content presentation device outputs the operation content.

One aspect of the present disclosure is the following operation content presentation device. The operation content presentation device includes a processor. The processor classifies an actual operation target and operation content through machine learning, with a response content used term of which is different among organizations being an input, and outputs an operation content expected to correspond to a response content and a software configuration of another organization.

### Advantageous Effects of Invention

According to one aspect of the present disclosure, even in a case where a plurality of environments are included and each of the environments independently performs service management, the same type of operation information can be accumulated and shared regardless of differences among the environments. The objects, configurations, and effects other than those described above will be apparent through the following description of embodiments.

### BRIEF DESCRIPTION OF DRAWINGS

FIG. 1 is a diagram illustrating an example of a macroscopic configuration to which an operating procedure presentation device including an operating procedure presentation method of a first embodiment of the present invention is applied.

FIG. 2 is a diagram illustrating an example of a configuration to which the operating procedure presentation device including the operating procedure presentation method is applied.

FIG. 3 is a block diagram illustrating a configuration of an operating procedure presentation device.

FIG. 4 is a block diagram illustrating processing executed on a main memory of the operating procedure presentation device and information managed by a storage device.

FIG. 5 is a diagram illustrating an example of a software mapping table.

FIG. 6 is a diagram illustrating an example of an operation mapping table.

FIG. 7 is a diagram illustrating an example of a dialect mapping table.

FIG. 8 is a diagram illustrating an example of an operation target table.

FIG. 9 is a diagram illustrating an example of a data source table.

FIG. 10 is a diagram illustrating an example of operations and time points.

FIG. 11 is a diagram illustrating an example of an operation data table.

FIG. 12 is a diagram illustrating an example of an operation overview table.

FIG. 13 is a flowchart for describing details of operation data table generation processing.

FIG. 14 is a diagram illustrating an example of a commonization operation table.

FIG. 15 is a flowchart for describing details of commonization operation table generation processing.

FIG. 16 is a flowchart for describing details of similarity calculation processing.

FIG. 17 is a flowchart for describing details of host acquisition processing.

FIG. 18 is a diagram illustrating an example of an environment for describing environment similarity.

FIG. 19 is a diagram illustrating an example of a screen displayed through operating procedure display processing.

FIG. 20 is a diagram illustrating an example of a recommendation level table.

FIG. 21 is a block diagram illustrating processing executed on a main memory of an operating procedure presentation device and information managed by a storage device according to a second embodiment of the present invention.

FIG. 22 is a diagram illustrating an example of an operating procedure learning table and a symptoms/action mapping table of a procedure identification DB.

FIG. 23 is a flowchart for describing details of learning table generation processing.

FIG. 24 is a diagram illustrating an example of a screen displayed through operating procedure display processing.

FIG. 25 is a flowchart for describing details of procedure identification processing.

### DESCRIPTION OF EMBODIMENTS

Embodiments of the present invention will be described below with reference to the accompanying drawings. The embodiments are examples for describing the present invention, and are omitted and simplified as appropriate for clarification of the description. The present invention can be implemented in other various forms. Unless otherwise limited, each component may be singular or plural.

In order to facilitate understanding of the invention, a position, size, shape, range, and the like of each component illustrated in the drawings may not necessarily represent an actual position, size, shape, range, and the like. Therefore, the present invention is not necessarily limited to the position, size, shape, range, and the like disclosed in the drawings.

Examples of various types of information may be described using expressions such as “table”, “list”, and “queue”, whereas various types of information may be expressed using other data structures. For example, various types of information such as “XX table”, “XX list”, and “XX queue” may be referred to as “XX information”. Expressions such as “identification information”, “identifier”, “name”, “ID”, and “number”, which are used for describing identification information, can be replaced with each other.

When there is a plurality of components having the same or similar functions, the same reference numerals may be given different suffix numerals for description. However, when it is not necessary to distinguish the plurality of components, the suffix numerals are omitted.

In the embodiments, processing performed by executing a program may be described. A computer executes processing in accordance with the program being executed by a processor (for example, CPU, GPU) while using a storage resource (for example, a memory) and/or an interface device (for example, a communication port). Thus, the subject of the processing performed by executing the program may be the processor. Similarly, the subject of the processing performed by executing the program may be a controller, a device, a system, a computer, or a node having a processor. It suffices if the subject of the processing performed by executing the program is a calculation unit, and may include a dedicated circuit for executing certain processing. The dedicated circuit is, for example, a field programmable gate array (FPGA), an application specific integrated circuit (ASIC), a complex programmable logic device (CPLD), or the like.

The program may be installed on a computer from a program source. The program source may be, for example, a program distribution server or a computer-readable storage medium. When the program source is the program distribution server, the program distribution server includes a processor and a storage resource for storing a program to be distributed, and the processor of the program distribution server may distribute the program to be distributed to another computer. In the following examples, two or more programs may be implemented as one program, or one program may be implemented as two or more programs.

The present disclosure relates to a technique of presenting operation information collected and accumulated from a plurality of environments. With the operation information shared among the plurality of environments, the operation cost can be reduced to make a contribution in an economical point of view for example. The operation information may include information indicating operating procedures.

### First Embodiment

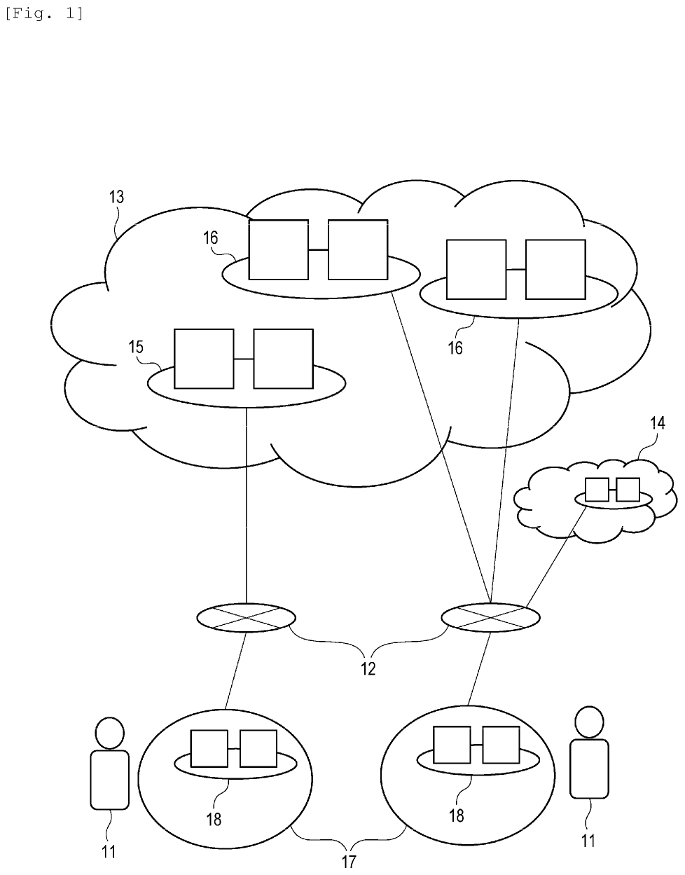

FIG. 1 illustrates an overview of an environment in which an operating procedure presentation device (operation information presentation device) including an operating procedure presentation method (operation information presentation method) according to one aspect of the present disclosure operates. An IT operations administrator 11 of each organization has a machine group 18 providing a service established on a network 17 in the organization, and also has a physical or virtual machine group in a public cloud 13 connected over the Internet 12. There are a case 15 where a machine group is provided in one region in the public cloud 13 and a case 16 where machine groups are provided in a plurality of regions. Furthermore, a physical or virtual machine group may be provided in a public cloud 14 provided by another cloud vendor.

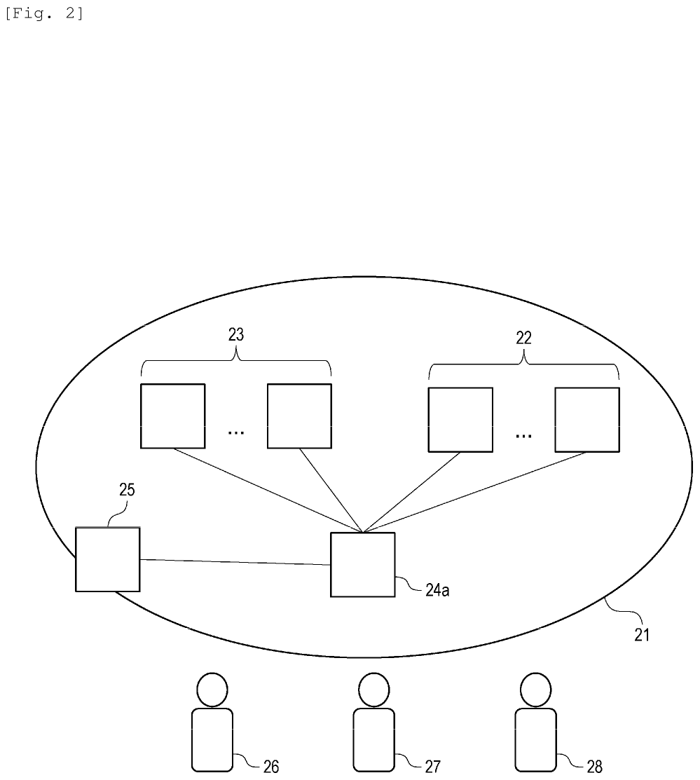

A description will be given on an example of an overall configuration in a case where the operating procedure presentation device including the operating procedure presentation method is applied to the organization in FIG. 2. There are provided a machine group 22 that provides a service in the host organization or a public cloud 21, a machine group 23 that monitors and controls the machine group 22, and an operating procedure presentation device 24a that is a machine that collects and manages operating procedures. The operating procedure presentation device 24a collects and accumulates information required for generating the operating procedures from the machine groups 22 and 23, and from a management function 25 provided by the cloud vendor in the case of the public cloud.

Since the object is to accumulate operating procedures in a plurality of environments and present the operating procedures executed and accumulated in the other environments to a different environment, while the operating procedure presentation device 24a is arranged in each organization/each environment in FIG. 2, there is an operating procedure presentation device serving as a reference. Thus, the operating procedure presentation device is shared by the organizations/environments. IT operations administrators 26 of the respective environments connect to the machine group 22 through the management function 25 provided by the public cloud, directly connect to the machine group 22, or use the machine group 23 that monitors and controls the machine group 22 to monitor whether the machine group 22 is providing a stable service and if there is a problem, request a system engineer (maintenance SE) 27 for responses. There may be a ticket administrator 28 that manages a ticket management system for recognizing a response status for the failure, in addition to the IT operations administrator 26 and the maintenance SE 27.

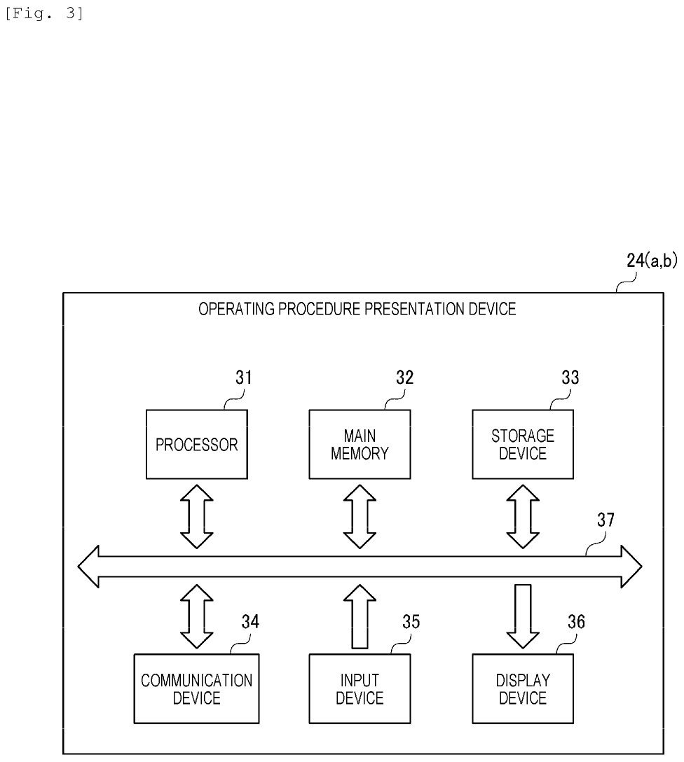

FIG. 3 is a block diagram illustrating a configuration of an operating procedure presentation device 24 (a, b). The operating procedure presentation device 24 (a, b) has a configuration in which a processor 31, a main memory 32, a storage device 33, a communication device 34, an input device 35, and a display device 36 are connected to each other via a bus 37. The processor 31 executes a software program loaded on the main memory 32 from the storage device 33, to implement functions required for operating procedure presentation. The communication device 34 is a configuration for connecting to the management function 25 provided by the machine groups (22, 23) and the public cloud over the network. The input device 35 is a configuration used for inputting information to a table set to the storage device 33 for example. The display device 36 is a configuration for displaying/outputting a result of execution by the processor 31.

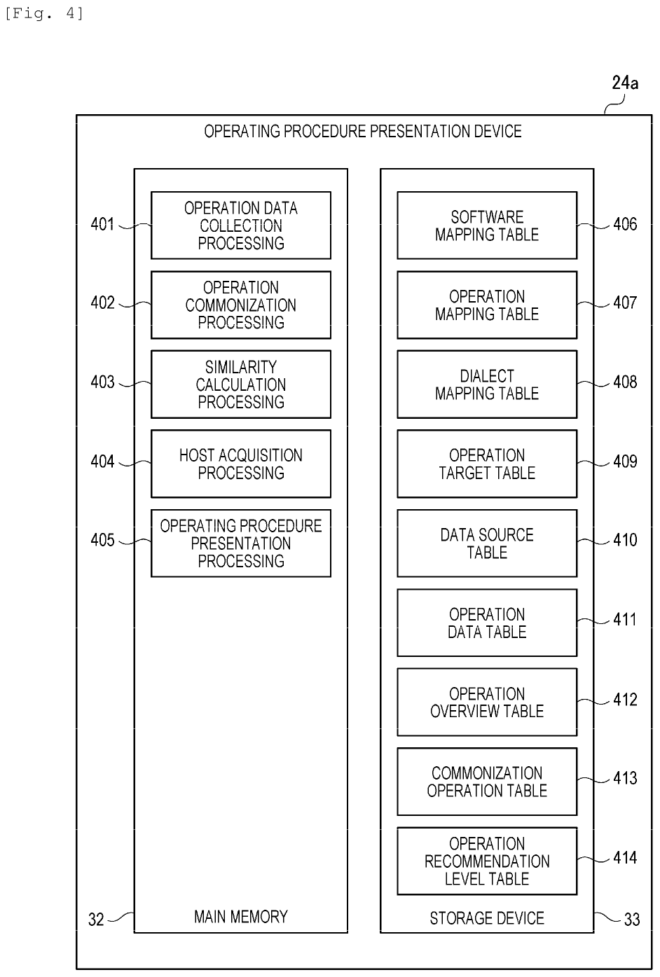

FIG. 4 illustrates a software program that runs on the main memory 32 of the operating procedure presentation device 24a and management information stored on the storage device 33. Executed on the main memory 32 are operation data collection processing 401 of collecting data on an operation that has occurred in the organization 21, operation commonization processing 402 of commonalizing the operation data collected from each organization, similarity calculation processing 403 of calculating environment similarity serving as an index for the maintenance SE 27 to determine whether accumulated operating procedures to be presented are adoptable in an environment that is the target of the presentation, host acquisition processing 404 of acquiring a host on which the same type of software runs in different organizations, and operating procedure display processing 405 of displaying the operating procedures accumulated.

The storage device 33 includes a software mapping table 406 in which the name of software used in each organization is converted into a general name, an operation mapping table 407 indicating the inclusive relationship between the operating procedures, a dialect mapping table 408 in which jargons used in the organizations are converted into general terms, an operation target table 409 in which operation target machines, management tools, and management services are registered, a data source table 410 in which an operation data collection target is registered, an operation data table 411 in which each operation in the operating procedures is recorded, an operation overview table 412 storing an operation overview for each organization, a commonization operation table 413 in which operation data corresponding to the operation overview is accumulated in a general format, and an operation recommendation level table 414 holding a recommendation level for each of the operating procedures.

The operating procedure presentation method in the operating procedure presentation device 24a with the configuration described above will be described below. First of all, the software mapping table stored in the storage device 33 will be described.

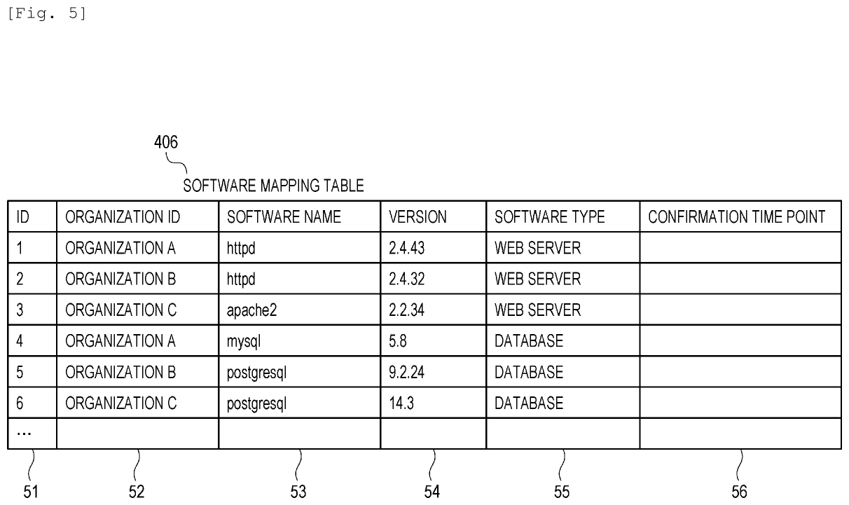

FIG. 5 is a diagram illustrating an example of the software mapping table 406. The software mapping table 406 stores information on software used in each organization. The software mapping table 406 includes an ID 51 uniquely identifying software owned by an organization, an organization ID 52 uniquely identifying the organization, a name 53 of the software owned by the organization, a version 54 of the software installed, a type 55 of the software, and a time point 56 when the installation of the software of the version in the organization is confirmed. In the present embodiment, the organization ID 52 includes the organization names of the organizations belonging to all the environments that can be the target of the collection by the operating procedure presentation device. The software name 53 includes a character string acquired through a general method of using a command for outputting the name of the software that has been installed, from the machine group 22 that provides the service and the machine group 23 that monitors and controls the machine group 22. The version 54 includes a character string included to be subsequent to the software name and obtained when the command that is the same as that for the software name 53 is used. The software type 55 includes a character string such as “Web server” and “database” uniquely identifying the service provided by the character string in the software name 53. The confirmation time point 56 includes the time point at which the command for acquiring the software name 53 was executed. The operating procedure presentation device 24a periodically executes the command for acquiring the software name 53, and updates the software mapping table 406 when there is a difference.

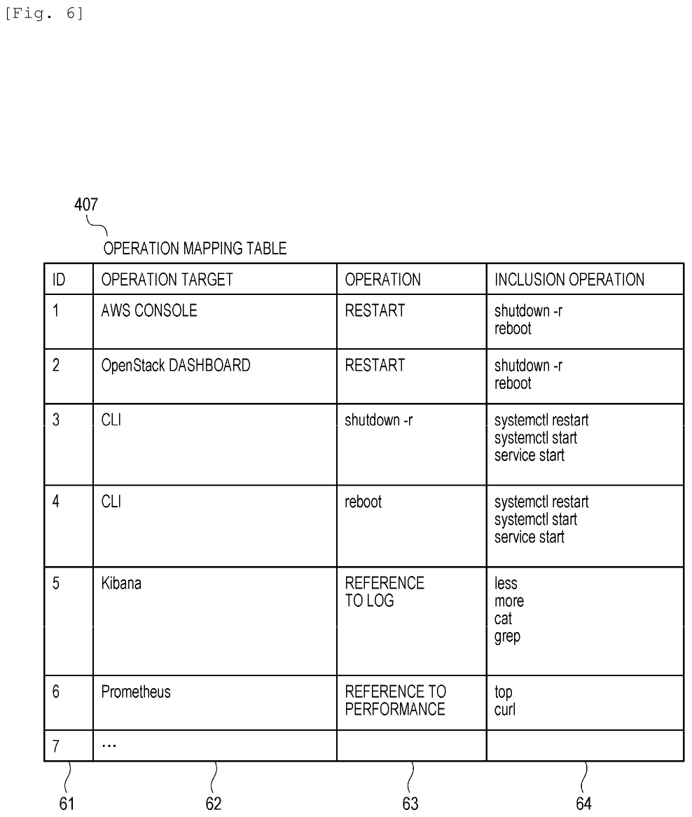

FIG. 6 is a diagram illustrating an example of the operation mapping table 407. The operation mapping table 407 stores information on the operation the content of which is the same for a predetermined operation. The operation mapping table 407 includes an ID 61 uniquely identifying the mapping, an operation target 62, an operation 63, and an inclusion operation 64. In the present embodiment, the ID 61 is automatically given as a serial number. The operation target 62 includes a character string such as “AWS console” and “OpenStack dashboard” indicating a management console of Amazon Web Service and OpenStack, which is an open source cloud management technique, “CLI” indicating execution of a command after a machine login, and “Kibana” that is software having a user interface for log monitoring. The operation 63 includes a command actually executed when the value of the operation target 62 is “CLI”. For the operation on a user interface such as “AWS console”, “OpenStack dashboard”, and “Kibana”, a character string that is easily understandable by a person is stored. The inclusion operation 64 includes a command e group executed when each function is substituted by a command line. Restart is the operation that is the same as that in a case where a “shutdown -r” or “reboot” command is executed, and thus “shutdown -r” and “reboot” are stored for restart. Similarly, the “shutdown -r” command corresponds to an operation that is the same as that in a case where “systemctl restart”, “systemctl start”, and “service start” are executed, and thus “systemctl restart”, “systemctl start”, and “service start” are stored as the inclusion operation 64 with the ID 61 having a value 3.

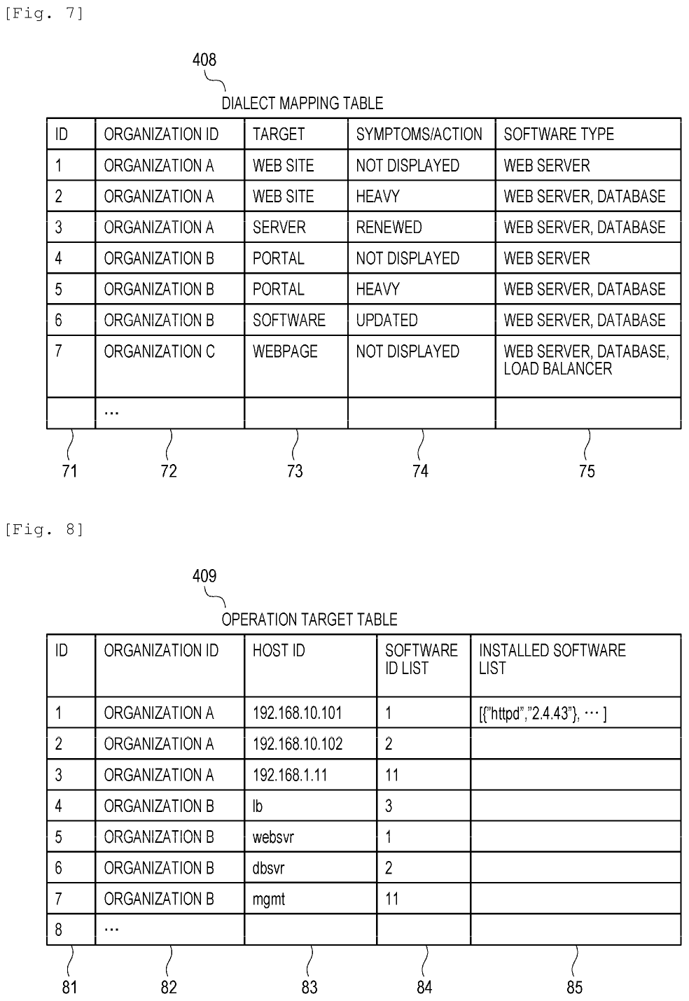

FIG. 7 illustrates an example of a configuration of the dialect mapping table 408. The dialect mapping table 408 (term mapping table) stores information on the terms used in each organization. The dialect mapping table 408 includes an ID 71 uniquely identifying the mapping, an organization ID 72 uniquely identifying an organization, a dialect (target) 73 used in the organization corresponding to the value of the organization ID 72, a dialect (symptoms/action) 74 used in the organization corresponding to the value of the organization ID 72, and a software type 75 that is the target of the operation when the combination of the dialect (target) 73 and the dialect (symptoms/action) is used in the organization corresponding to the value of the organization ID 72. In the present embodiment, the value 1 of the ID 71 indicates that, when a dialect “website” being “not displayed” is used in “organization A”, the software type that is the starting point of the operation is “Web server”. The value 4 of the ID 72 indicates that, when a dialect “portal” being “not displayed” is used in “organization B”, the software type that is the starting point of the operation is “Web server” also in this case. The value 6 of the ID 72 indicates that, when a dialect “software” being “updated” is used in “organization B”, the software types to be the operation targets are “Web server” and “database”. The software type 75 includes a failure that occurred in the past in each organization as well as a normal operation and the software type that is the operation target of the operation.

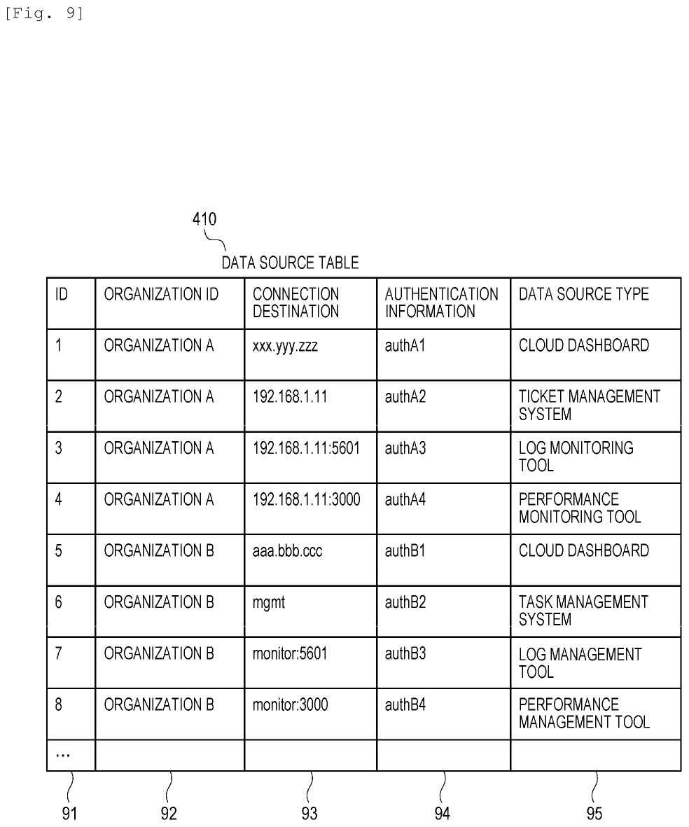

FIG. 8 illustrates an example of a configuration of the operation target table 409. The operation target table 409 includes an ID 81 uniquely identifying an operation target, an organization ID 82 uniquely identifying an organization, a host ID 83 identifying a host to be the operation target, a list 84 of IDs of software included in the operation target, and a list 85 of software actually installed. In the present embodiment, the operation target table 409 stores a target on which each of the operations in the operating procedures is performed. In the present embodiment, for the organization ID 82, the value that is the same as that used for the organization ID 52 of the software mapping table 406 and the organization ID 72 of the dialect mapping table 408 is used. As a value of the host ID 83, a value, such as an IP address or a host name, communicable within the environment indicated by the organization ID 82 is used. As values of the software ID list 84, numerical values corresponding one-to-one with the values of the software type 55 in the software mapping table 406 are used. When a plurality of types of software are installed, they are registered while being distinguished from each other with commas. The values of the installed software list 85 are assumed to be information as a result of listing combinations of the values of the software name 53 and the version 54 in the software mapping table 406. The operation target table 409 stores all the operation targets in each organization.

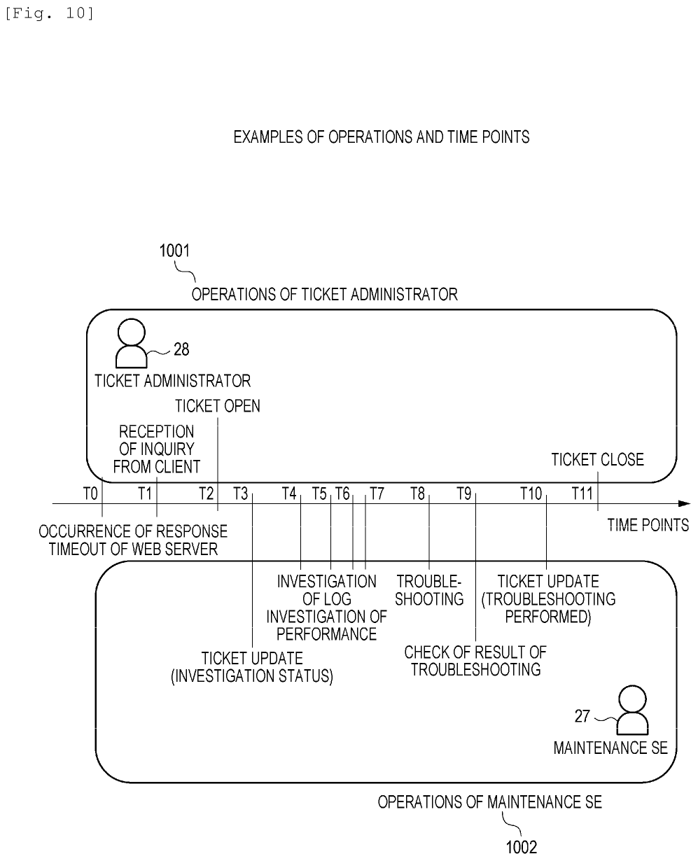

FIG. 9 illustrates an example of a configuration of the data source table 410. The data source table 410 includes an ID 91 uniquely identifying a data source, an ID 92 of an organization to which the data source belongs, connection destination information 93 to the data source, authentication information 94, and a data source type 95. The organization ID 92 includes a value that is the same as that of the organization ID 52 of the software mapping table 406. The connection destination information 93 to the data source includes an IP address, host name, and URL connectable from the operating procedure presentation device 24a. The authentication information 94 includes authentication information used for acquiring operation information from the connection destination, and a null value for a case requiring no authentication. The data source type 95 includes a character string as a result of commonization of the data source.

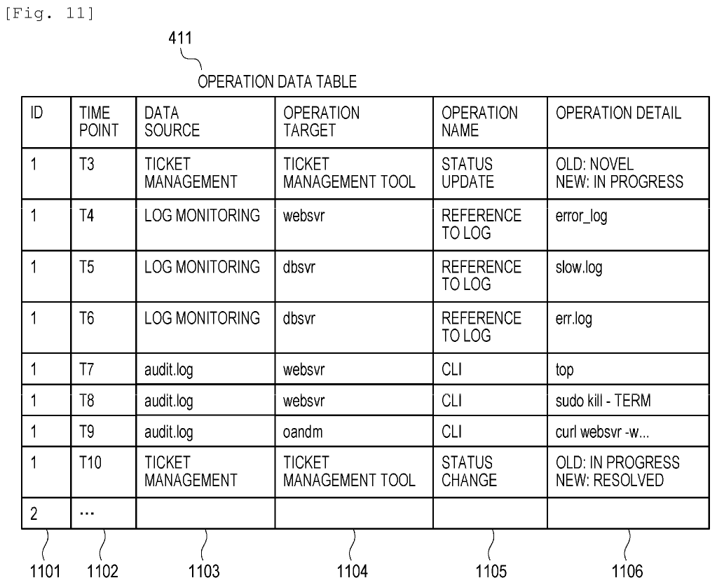

FIG. 10 illustrates examples of a plurality of operations that are the operating procedures, time points, and operations of each of the maintenance SE 27 and the ticket administrator 28 (operations 1001 of the ticket administrator and operations 1002 of the maintenance SE). At a time point T0, response timeout of the Web server occurs. At a time point T1, an inquiry from a client is received. At a time point T2, the ticket administrator 28 registers a new ticket in the ticket management system. Upon being notified of the registration of the ticket, the maintenance SE updates the ticket using the ticket management system to check and investigate the problem. Then, the maintenance SE investigates a log and performance to identify the cause in a period between time points T4 to T7. Then, troubleshooting is performed at a time point T8. After the result of the troubleshooting is checked at a time point T9, the ticket is updated at a time point T10 using the ticket management system since the troubleshooting is completed. Then, the ticket administrator 28 confirms the resolution of the failure, and closes the ticket. In this process, the maintenance SE is in charge of the operations performed in a period between the time points T3 and T10.

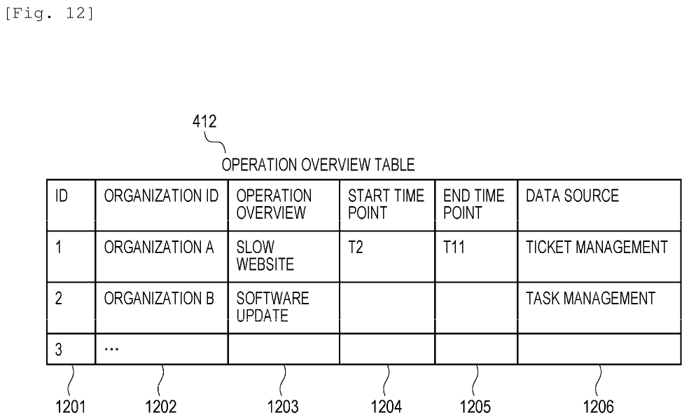

FIG. 11 is a diagram illustrating an example of a configuration of the operation data table 411. The operation data table 411 includes an ID 1101 uniquely identifying operating procedures to which operation data belongs, a time point 1102 at which an operation is performed, a data source type 1103, an operation target 1104, an operation name 1105, and an operation detail 1106.

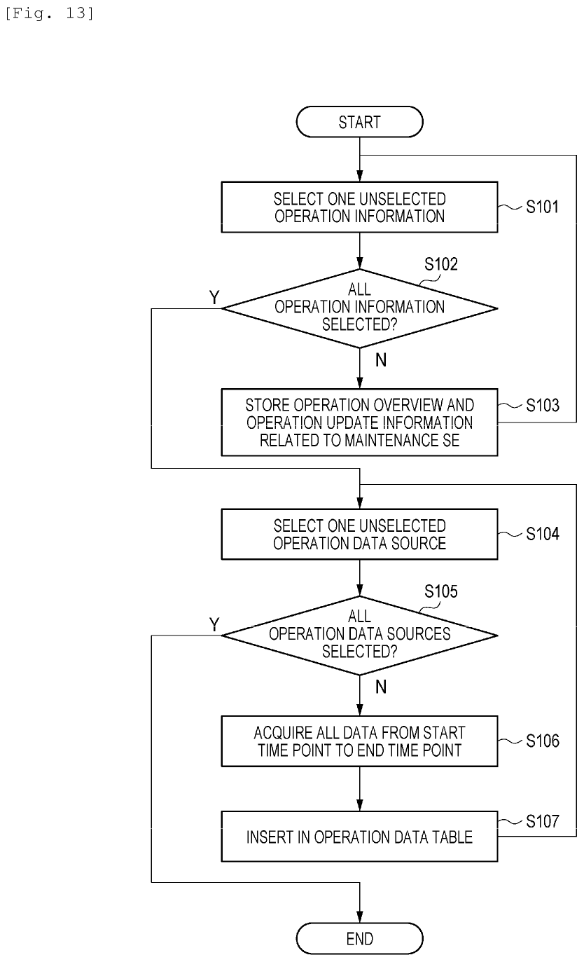

FIG. 12 is a diagram illustrating an example of a configuration of the operation overview table 412. The operation overview table 412 includes an ID 1201 uniquely identifying an operation, an organization ID 1202, an operation overview 1203, a start time point 1204, an end time point 1205, and a data source 1206. When a new row is inserted, a unique value is assigned as the ID 1201.

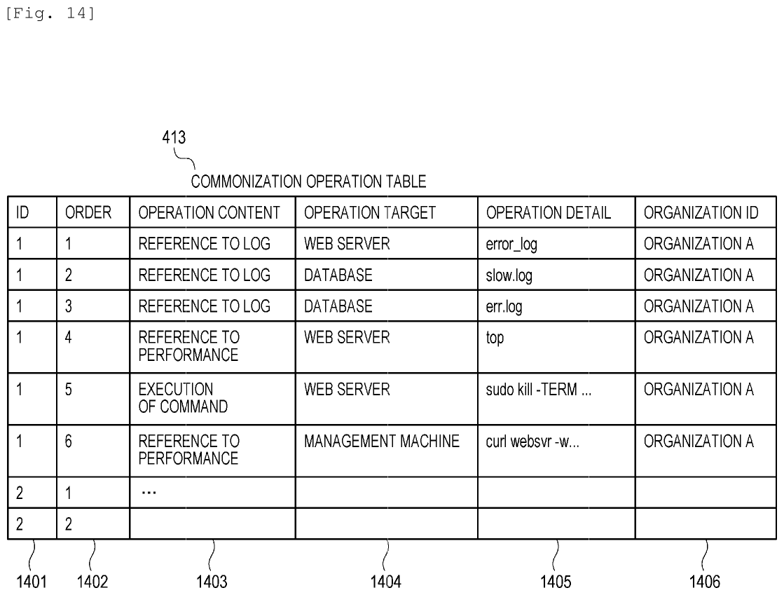

FIG. 13 illustrates a processing flow of the operation data collection processing 401 executed in the operating procedure presentation device 24a. The operation data collection processing 401 is executed using the operation data table 411 and the operation overview table 412, to compile the contents of the operations of the maintenance SE 27 corresponding to contents requiring responses (such as slow website) that are contents to be responded, such as troubleshooting for a failure and operation requests. In the operation data collection processing 401, first of all, one unselected operation information is selected (step S101). The operation information can be acquired by the ticket management system used in the present embodiment, and can also be acquired using a task management system or through communications using email and chat tools. The connection destination 93 and the authentication information 94 in the data source table 410 are used for the acquisition.

Next, in the operation data collection processing 401, whether all the operation information has been selected is identified (step S102). The processing proceeds to step S104 when all the operation information has been selected. When there is selected operation information, operation overview and all the operation update information related to the maintenance SE are acquired from the operation information. For the ticket management system, the operation update information means a ticket personnel, a value updated as a result of the troubleshooting such as a status indicating the ticket response status, and an update time point.

In the operation data collection processing 401, the ID of the organization in which the operation has been performed, the operation overview, the first operation update time point, the last operation update time point, the data source from which the operation information has been acquired, from the acquired operation update information, are inserted into the operation overview table 412 as the values of the organization ID 1202, the operation overview 1203, the start time point 1204, the end time point 1205, and the data source 1206 of the operation overview table 412. In the ticket management system, in addition to this, since the first update and the last update are performed as the operation by the ticket administrator 28 and not by the maintenance SE 27 as illustrated in FIG. 9, the target is from the second update to the update that is one before the last update. Here, the second update time point and the time point of the update that is one before the last update are held internally respectively as the operation start time point and the operation end time point.

For each operation update information, a value of the ID 1101 given when the corresponding operation is inserted to the operation overview table 412, an operation update time point, an operation information acquisition target (ticket management in the present embodiment), an operation target (ticket management tool in the present embodiment), and values before and after the update of the updated operation content (status in the present embodiment) are respectively set and inserted to an ID 1101, a time point 1102, a data source 1103, an operation target 1104, an operation name, and an operation detail 1106 of the operation data table 411. Then, the processing returns to step S101 (step S103).

Next, in the operation data collection processing 401, one unselected operation data source is selected (step S104). The operation data source means a file and a database in which the operation procedures are recorded, such as a log file recording a command executed by an OS or an OS that performs an operation on an operation target OS, the quality of the service and the status of the resource for the operation target, an access log for software for monitoring a log file output from software operating to provide services, and information on an operation event that has occurred on the cloud where the operation target is operating.

Next, in the operation data collection processing 401, whether there is no longer an unselected operation data source is identified (step S105). When the result of the identification indicates that there is no longer an unselected operation data source, the processing ends. When there is an unselected operation data source, data to be stored in the operation data table 411 is extracted from the data source, using the connection destination 93 and the authentication information 94 in the data source table (step S106).

In the operation data collection processing 401, a time point corresponding to each operation data is assigned to the time point 1102 in the operation data table 411, a numerical value (table also illustrated in FIG. 9 in the present embodiment) uniquely identifying the type of the acquired data source is assigned to the data source 1103, a value of the operation target obtained from the data source is assigned to the operation target 1104, and a value corresponding to the operation 63 in the operation mapping table 407 is assigned to the operation name 1105. In the operation data collection processing 401, a character string corresponding to the other data is assigned to the operation detail 1106, and if there is no corresponding value, a row assigned with a special value (hyphen “-” of a character string in the present embodiment) indicating the absence of the corresponding value is inserted (step S107). Then, the processing returns to step S104.

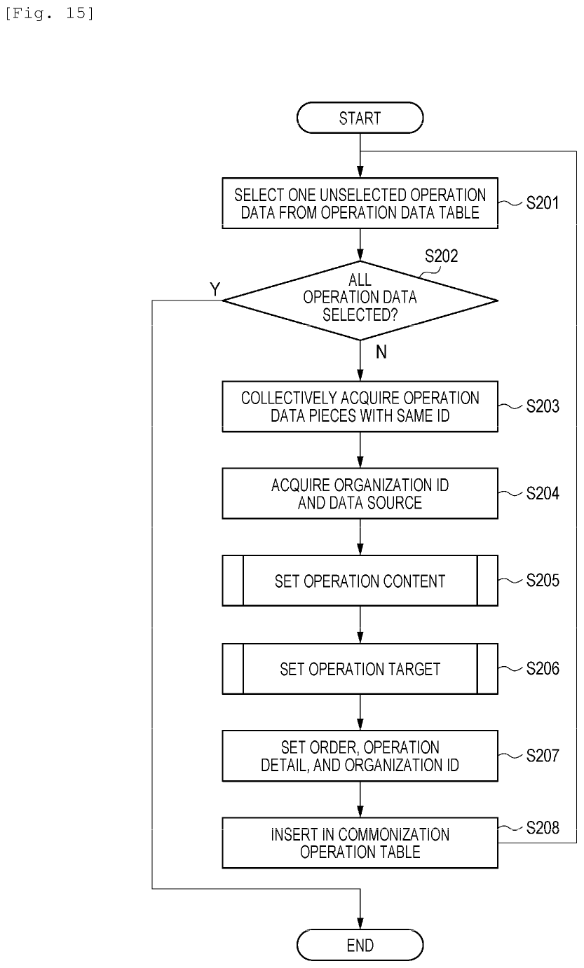

FIG. 14 illustrates an example of a configuration of the commonization operation table 413. The commonization operation table 413 includes an ID 1401 uniquely identifying an operation overview corresponding to a commonization operation, an order 1402 of operations executed, an operation content 1403, an operation target 1404, an operation detail 1405, and an organization ID 1406.

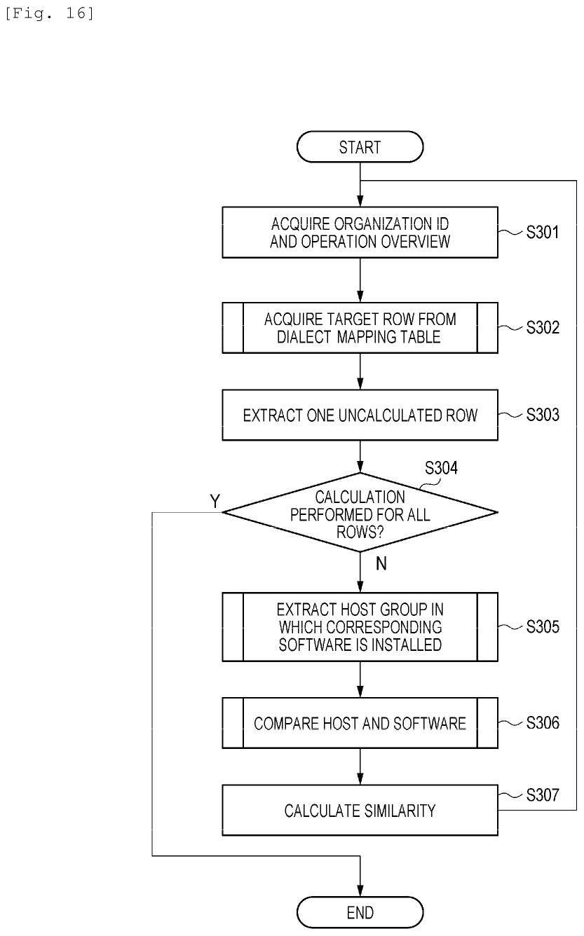

FIG. 15 illustrates a processing flow of the operation commonization processing 402. In the operation commonization processing 402, data is stored in the commonization operation table 413. In the operation commonization processing 402, first of all, one unprocessed operation data is acquired from the operation data table 411 (step S201). Next, whether all the operation data has been selected is identified (step S202). When all the operation data has been selected, the processing ends. When there is operation data, data pieces with the same value of the ID 1101 are collectively acquired (step S203).

Next, in the operation commonization processing 402, for the operation data acquired in step S201 and step S203, first of all, a value of the organization ID 1202 and a value of the data source 1206 in a row matching the value of the ID 1401 are acquired from the operation overview table 412 (step S204).

In the operation commonization processing 402, whether the value of the data source 1103 matches the value of 1206 is evaluated. When the values match, the operation data is not used for the commonization operation table. When there is a row with a value of the operation name 1105, as the value of the operation content, matching the operation 63 of the operation mapping table 407, the value is directly used as the value of the operation content. When there is no value matching the operation 63, whether the content of the operation detail 1106 is included in the inclusion operation 64 in the operation mapping table 407 is evaluated. When the content is included, the value of the operation 63 of the row in the operation mapping table 407 is set as the value of the operation content. When there is no match, a value indicating unknown (“unknown” for example) is set as the value of the operation content (step S205).

Next, in the operation commonization processing 402, the following processing is executed on the operation data that is the target of the processing in step S205. Data is searched for in which a combination of the value of the operation target 1104 in the operation data table 411 and the value of the organization ID acquired in step S204 matches a combination of the values of the host ID 83 and the organization ID 82 in the operation target table 409. When there is the matching data, data with a matching combination of the values of the software name 53 and the organization ID 52 in the software mapping table 406 is searched for, based on the values of the software name of the installed software list 85 and the organization ID 82 in the corresponding row in the operation target table 409. When there is the matching data, the value of the software type 55 in the corresponding row is set as the operation target. When there is no matching data, if there is the matching connection destination 93 in the data source table 410, the value of the data source type 95 is set as the operation target. When the data still does not match, a value (“general purpose machine” for example) indicating that the operation target is undetermined is set (step S206).

Furthermore, in the operation commonization processing 402, the values of the time point 1102 are organized into an ascending order for the operation data after steps S204 to S206, and order information is obtained with serial numbers assigned from the earlier time points. The value of the operation detail 1106 is internally held as is (step S207). Then, as a new row in the commonization operation table 413, the value of the ID used in step S201 and S203 is set and inserted to the ID 1401, the value given in step S207 is set and inserted to the order 1402, the value determined in step S205 is set and inserted to the operation content 1403, the value determined in step S206 is set and inserted to the operation target 1404, the value held in step S207 is set and inserted to the operation detail 1405, and the value acquired in step S204 is set and inserted to the organization ID 1406 (step S208). Then, the processing returns to step S201.

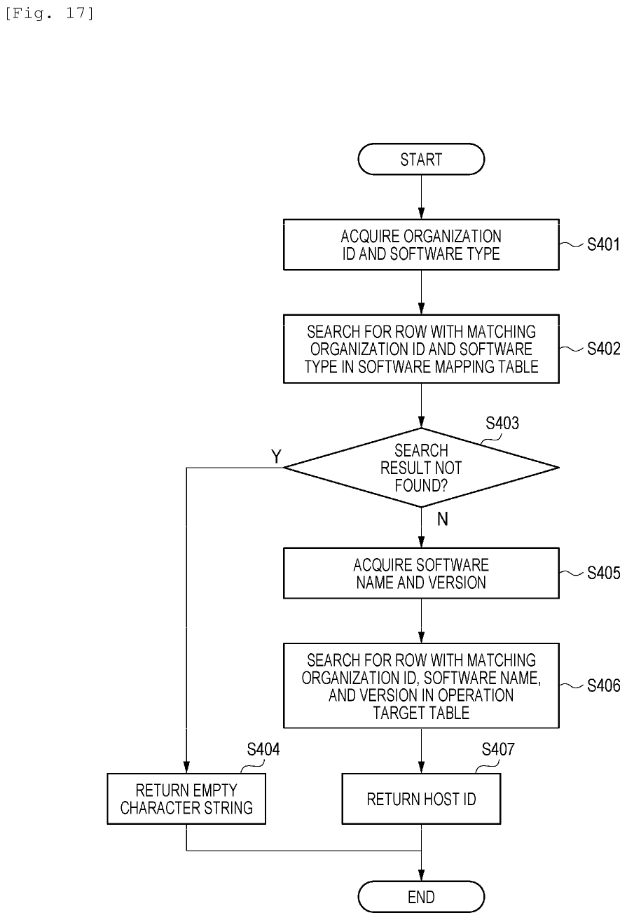

FIG. 16 illustrates a processing flow of the similarity calculation processing 403 in the operating procedure presentation device 24a. In the similarity calculation processing 403, first of all, the operation overview and the organization ID are acquired (step S301). The operation overview is the value of the operation overview 1203 stored in the operation overview table 412 or a character string freely input. The organization ID can be identified from the operating procedure presentation device information used by the maintenance SE.

Next, in the similarity calculation processing 403, a reference is made on each row in the dialect mapping table 408. When the organization ID acquired in step S301 matches the organization ID 72, a row with the target 73 and symptoms/action 74 in the dialect mapping table 408 both included in the operation overview acquired in step S301 is internally held. When the organization ID does not match, a row with at least one of the target 73 and the symptoms/action 74 matching is internally held (step S302).

Next, in the similarity calculation processing 403, one uncalculated row is extracted from the rows held in step S302 (step S303). Whether the similarity has been calculated for all the rows is evaluated (step S304), and the processing ends when the calculation has been performed for all the rows. When there is a row for which the similarity has not been calculated yet, the processing described below is executed.

First of all, in the similarity calculation processing 403, the software type 75 is acquired from the row extracted in step S303, the host corresponding to the software type is acquired, using the organization ID, from the operating procedure presentation device information used by the maintenance SE (processing detail will be described in the host acquisition processing 404), and the value of the ID 51 of the row with the organization ID 52 and the software type 55 matching is selected from the software mapping table 406.

In the similarity calculation processing 403, when there are a plurality of matching IDs, one with the latest confirmation time point 56 is selected, and the software name 53 and the version 54 are acquired and internally held. Furthermore, with reference to the values of the organization ID 82 and the installed software list 85 in the operation target table 409, the host ID of the row with the installed software list 85 including the combination of the software name 53 and the version 54 internally held is acquired (step S305).

Next, in the similarity calculation processing 403, the host, the software name, and the version are compared (step S306). As will be described below as an example, the similarity is obtained as a numerical value with the denominator being the number of types of software in the organization with a large number of software units, and with the numerator including three patterns of (1) a software type matching count, (2) a software name matching count, and (3) a software name and version matching count (step S307).

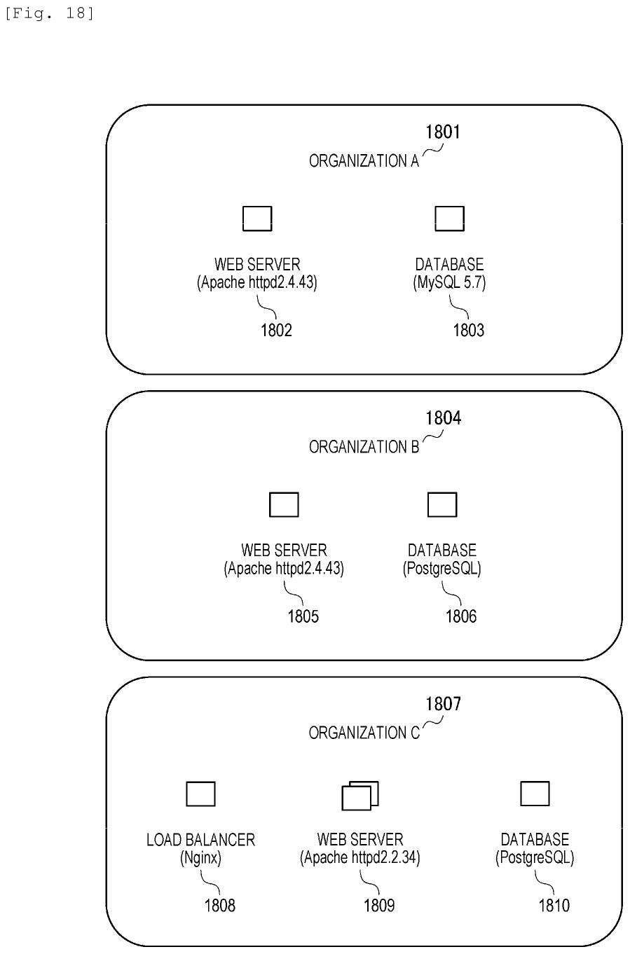

FIG. 17 illustrates a processing flow of the host acquisition processing 404. In the host acquisition processing 404, first of all, the organization ID and the software type are acquired as inputs (step S401). Next, a row is searched for in which the values of the organization ID 52 and the software type 55 in software mapping table 406 match the values acquired in step S401 (step S402).

Next, in the host acquisition processing 404, whether the search result is found is identified (step S403). When the search result is not found, a value (an empty character string in the present embodiment) indicating that the relevant organization does not include a host with the target software type installed is returned, and the processing ends (step S404). When a plurality of the search results are found, one with the latest confirmation time point 56 is selected.

Next, in the host acquisition processing 404, the values of the software name 53 and the version 54 are acquired from the selected row, and are internally held (step S405). Then, the operation target table 409 is searched for a row in which the value of the organization ID 82 is the same as the value of the organization ID that is the input information, and the software name and the version internally held are included in the values of the installed software list 85 (step S406). The value of the host ID 83 is returned from the row as the search result, and the processing ends (step S407).

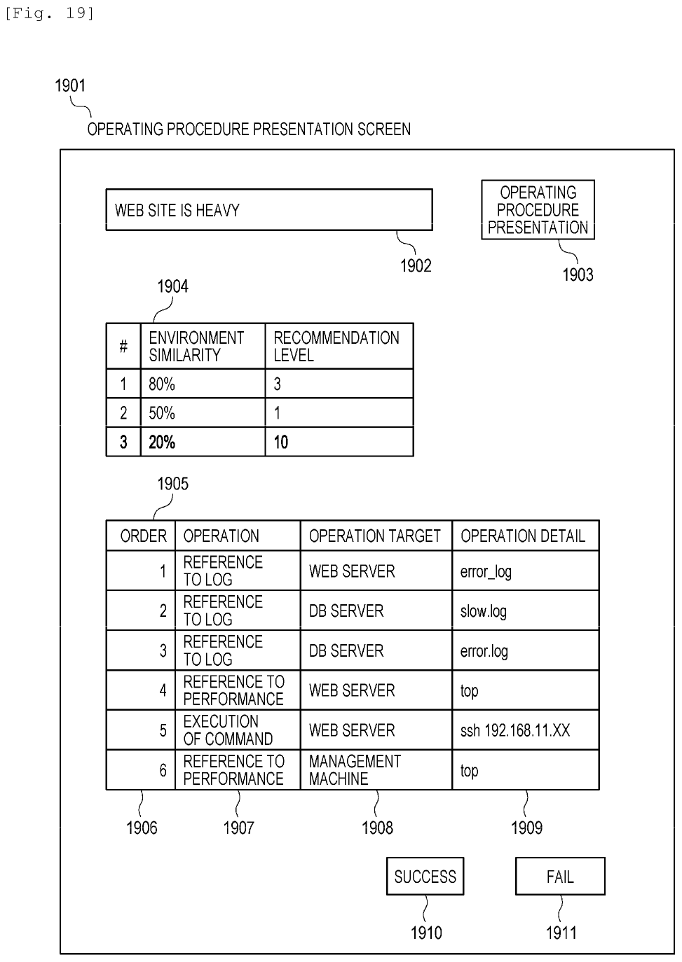

FIG. 18 is a diagram illustrating a specific example of the similarity calculation. Assuming that an environment A 1801 is a comparison source environment, and a Web server 1802 and a database 1803 are operation target software, similarities (1), (2), and (3) of an environment B 1804 that are respectively the similarities according to (1), (2), and (3) described above are respectively 1/1 because the software types of a Web server 1805 and a database 1806 are the same, ½ because the software name of the Web server 1805 is the same but the software name of the database 1806 is different, and ½ because the software and the version of the Web server 1805 are the same but the software and the version of the database 1806 are different.

Similarly, regarding an environment C 1807, the similarity (1) is ⅔ because the operation target includes a load balancer 1808 in addition to a Web server 1809 and a database 1810, the similarity (2) is ⅓ because only the software name of the Web server 1809 matches, and the similarity (3) is 0/3 because there is no match.

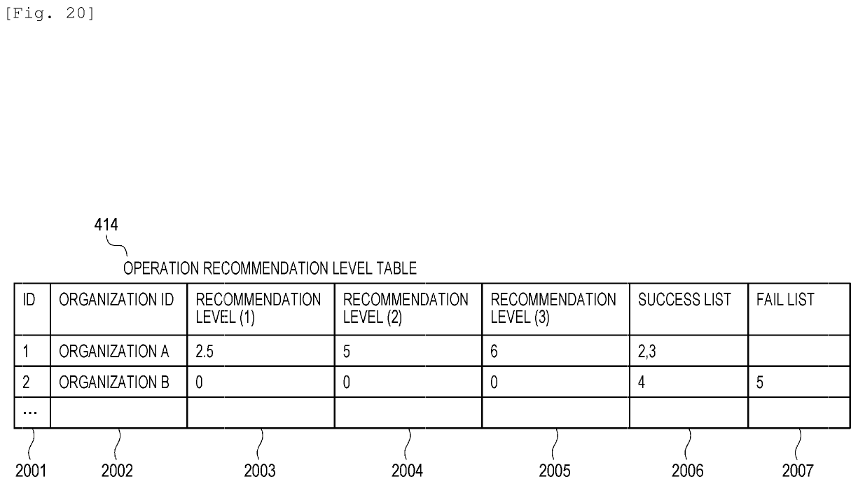

FIG. 19 illustrates an example of an operating procedure presentation screen displayed through the operating procedure presentation processing 405. The operating procedure presentation screen 1901 includes an operation overview display field 1902, an operating procedure presentation button 1903, an operating procedures list display area 1904, an operating procedure display area 1905, a success button 1910, and a fail button 1911.

The operation overview display field 1902 displays a character string input by the maintenance SE 27, or a character string acquired as the operation overview of the ticket management system or the task management system. When the maintenance SE 27 presses the operating procedure presentation button 1903, the similarity calculation processing 403 is executed based on the content of the operation overview display field 1902 and the ID of the organization calling the operating procedure presentation screen. Then, the operating procedures list display area 1904 displays the similarity calculated and the value acquired from the operation recommendation level table 414 described below.

In this process, in the operating procedure presentation processing 405, the software as the operation target included in the operating procedures is compared with the software of the organization calling the operating procedure presentation screen. When there is a difference, it is displayed that the use of the operating procedures involves a risk.

The ID in the operating procedures list display area 1904 is not an ID of the operation overview corresponding to the similarity, and is a unique number for distinguishing the operating procedures in the list. The ID of the operation overview corresponding to the similarity is internally held, and when the maintenance SE 27 selects any of the rows of the operating procedures list display area 1904, in the operating procedure presentation processing 405, based on the value of the ID, a procedure matching the ID 1401 of the operation commonization table 411 is displayed in the operating procedure display area 1905.

As an order 1906, an operation 1907, an operation target 1908, and an operation detail 1909 of the operating procedure display area 1905, values of the order 1402, the operation content 1403, the operation target 1404, and the operation detail 1405 in the commonization operation table 413 are displayed respectively.

In the host acquisition processing 404, the operation target 1908 may be switched to the ID of the host in which the corresponding software is installed in the organization, and displayed. The operation 1907 can be switched to a value of the inclusion operation 64 in the row matching the operation 63 in the operation mapping table 407. When the value of the operation 1907 is included in the values of the data source type in the data source table 410, the value of the operation detail 1909 may be a URL displayed as connection destination information.

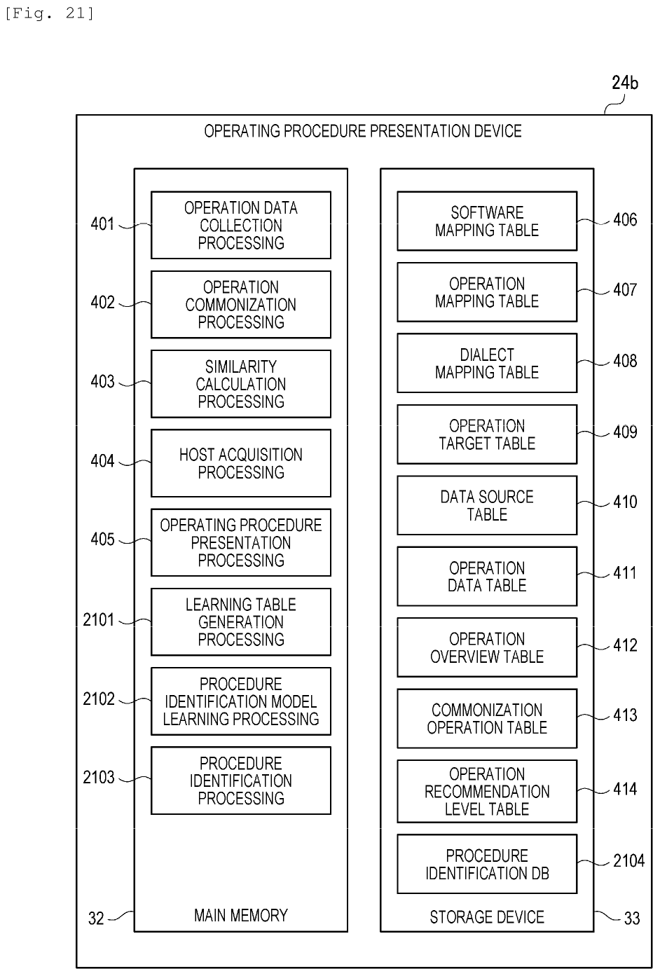

FIG. 20 illustrates an example of a configuration of the operation recommendation level table 414. The operation recommendation level table 414 includes an ID 2001, an organization ID 2002, a recommendation level (1) 2003, a recommendation level (2) 2004, a recommendation level (3) 2005, a success list 2006, and a fail list 2007.

As the ID 2001, the value that is the same as that of the ID 1201 of the operation overview table 412 is stored. Similarity, as the organization ID 2002, the value that is the same as that of the organization ID 1202 of the operation overview table 412 is stored. The initial values of the recommendation level (1) 2003, the recommendation level (2) 2004, and the recommendation level (3) 2005 are 0.

When the success button 1910 on the operating procedure presentation screen is pressed, the processor 21 adds the reciprocals of the similarities (1) to (3) calculated by the similarity calculation processing 403 to the recommendation level (1) 2003, the recommendation level (2) 2004, and the recommendation level (3) 2005. When the similarity is 0, the processor 21 adds a value as a result of adding 1 to the maximum value of the software type 75 of the dialect mapping table 408. Furthermore, the value of the corresponding ID 1201 in the operation overview table 412 is added to the success list 2006.

On the other hand, when the fail button 1911 is pressed, the processor 21 performs subtraction using the values obtained by subtracting the reciprocals of the similarities (1) to (3), and when the similarity is 0, using the value as a result of adding 1 to the maximum value of the software type 75 of the dialect mapping table 408. The subtraction result of a negative value is rounded to 0. Then, the processor 21 adds the value of the corresponding ID 1201 in the operation overview table 412 to the fail list 2007.

When the fail list includes the value of the ID in the operation overview table 412 corresponding to the content of the operation overview display field 1902, in the operating procedure presentation processing 405, the operating procedures corresponding to the operating procedures list display area 1904 of the operating procedure presentation screen 1901 are displayed while being gray hatched or in any other like way, to indicate that the operating procedures may involve problems.

Thus, even in environments in which different organizations use different types of software configurations and dialects, the operating procedures can be commonalized and accumulated, and similar operating procedures can be presented. Furthermore, the similarity of the environment and the operation procedures with a successful result are displayed, so that the maintenance SE can review and refer to such information to determine whether operating procedures can be employed in his or her environment. The display mode can be changed as appropriate. For example, the layout in the screen can be changed as appropriate, and the item selected in the operating procedures list display area 1904 may be highlighted.

### Second Embodiment

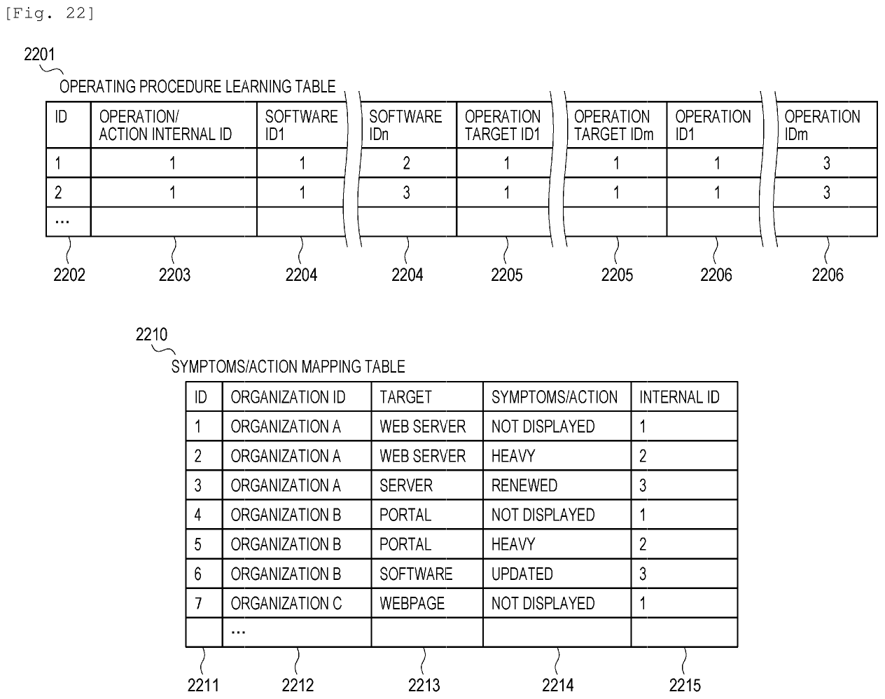

Next, a second embodiment of the present invention will be described with reference to FIGS. 21 to 25. FIG. 21 is a diagram illustrating a configuration of an operating procedure presentation device 24b of the second embodiment. The components that are the same as those in the above description may be denoted by the same reference numerals. A description on the configuration and the processing that are the same as those in the first embodiment will be omitted.

In FIG. 21, learning table generation processing 2101, procedure identification model learning processing 2102, procedure identification processing 2103, and a procedure identification DB 2104 used in the second embodiment are added. The procedure identification DB 2104 includes a procedure identification learning table 2201 and a symptoms/action mapping table 2210.

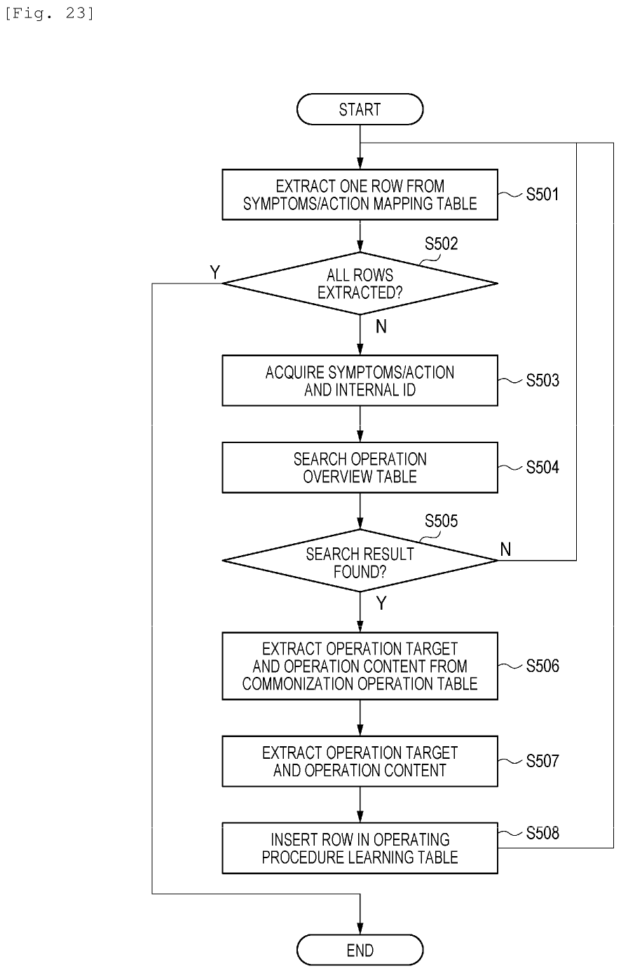

As illustrated in FIG. 22, the procedure identification learning table 2201 (operating procedure learning table) includes an ID 2202, an operation/action internal ID 2203, a software ID 2204, an operation target ID 2205, and an operation ID 2206. The software ID 2204, the operation target ID 2205, and the operation ID 2206 are each one or more IDs. In the present embodiment, the software ID 2204 is assumed to include the first to the nth IDs, and the operation target ID 2205 and the operation ID 2206 are each assumed to include the first to the mth IDs.

The symptoms/action mapping table 2210 is used for guiding a value to be stored as the operation/action internal ID 2203 of the procedure identification learning table 2201, and includes an ID 2211, an organization ID 2212, a target 2213, a symptoms/action 2214, and an internal ID 2215. The symptoms/action mapping table 2210 is data obtained by assigning the same internal ID 2215 for dialects corresponding to the same type of operating procedures, for each row in the dialect mapping table 408.

Specifically, as the ID 2211, the organization ID 2212, the target 2213, and the symptoms/action 2214, the values of the ID 71, the organization ID 72, the target 73, and the symptoms/action 74 in the dialect mapping table 408 are directly stored. For the internal ID 2215, the same internal ID is stored for the same type of operation in different organizations. In the present embodiment, operations for “Web server” and “not displayed” in “organization A”, for “portal” and “not displayed” in “organization B”, and for “webpage” and “not displayed” in “organization C” are of the same type, and thus are denoted by the same internal ID that is 1.

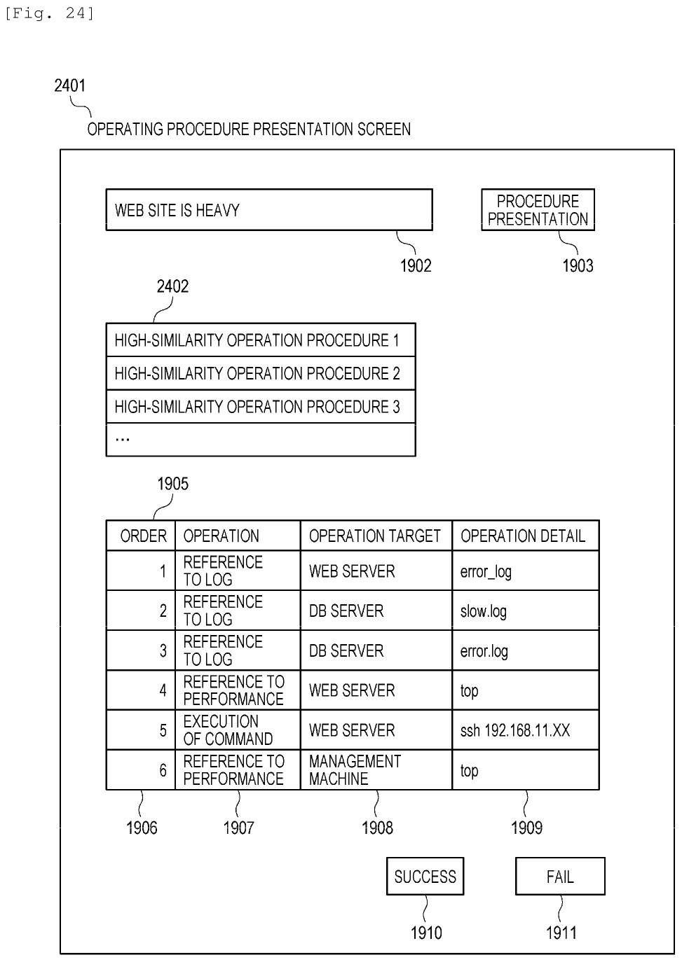

FIG. 23 illustrates a processing flow of the learning table generation processing 2101 of thus storing the value in the operating procedure learning table 2201. In the learning table generation processing 2101, first of all, one row is extracted from the symptoms/action mapping table 2210 (step S501).

Next, in the learning table generation processing 2101, whether all the rows have been extracted is identified (step S502). When all the rows have been extracted, the processing ends. Otherwise, the values of the organization ID 2212, the target 2213, and the symptoms/action 2214 in the row extracted in step S501 are then extracted, and the value of the corresponding internal ID 2115 is acquired from the symptoms/action mapping table 2210, and these values are internally held (step S503).

Furthermore, in the learning table generation processing 2101, the operation overview table 412 is searched for a row that has the same organization ID 1202 and has the value of the operation overview 1203 including the values of both the target and the symptoms/action (step S504). Whether the search result is found is identified (step S505). The processing returns to step S501, when the search result is not found. When the search result is found, the values of the operation target 1404 and the operation content 1403 are extracted from the corresponding row in the commonization operation table 411 (S506). Then, using the software type, which is the value of the operation target, and the value of the organization ID used in step S504, the software mapping table 406 is searched for the row matching the software type 55 and the organization ID 52. The value of the ID 51 as the search result is internally held (step S507).

After all the values of the operation target 1404, the operation content 1403, and the software ID 51 have been held, in the learning table generation processing 2101, a new row of the software ID 2204 is inserted in the operating procedure learning table 2201 with the value held in step S503 stored as the operation/action internal ID 2203, the value held in step S507 stored as a software ID1 to a software IDn (2204), the value held in step S506 stored as an operation target ID1 to an operation target IDm (2205), and the value also held in step S506 stored as an operation ID1 to an operation IDm (2206). When the number of software IDs is less than n, and when the numbers of operation IDs and operation target IDs are less than m, a numerical value (0 for example) indicating the absence of the corresponding ID is stored in an extra portion. As the ID 2202, a unique value automatically assigned is stored at the time of the insertion (step S508).

A processing flow of the procedure identification model learning processing 2102 will be described. The procedure identification model learning processing is executed at a predetermined timing, or a timing when the operating procedure learning table is updated. In each row of the operating procedure learning table 2201, the numerical value of the operation/action internal ID 2203 is used as an object variable, and the software ID 2204, the operation target ID 2205, and the operation ID 2206 are used as explanatory variables, to perform machine learning (for example, learning based on decision tree such as random forest, or learning based on deep learning) for the feature values of the explanatory variables. Thus, the relationship between the explanatory variables and the objective variable is learned, and the feature values related to the explanatory variables and the objective variable are calculated. A combination of the objective variable and the explanatory variables calculated is stored in the storage device 33.

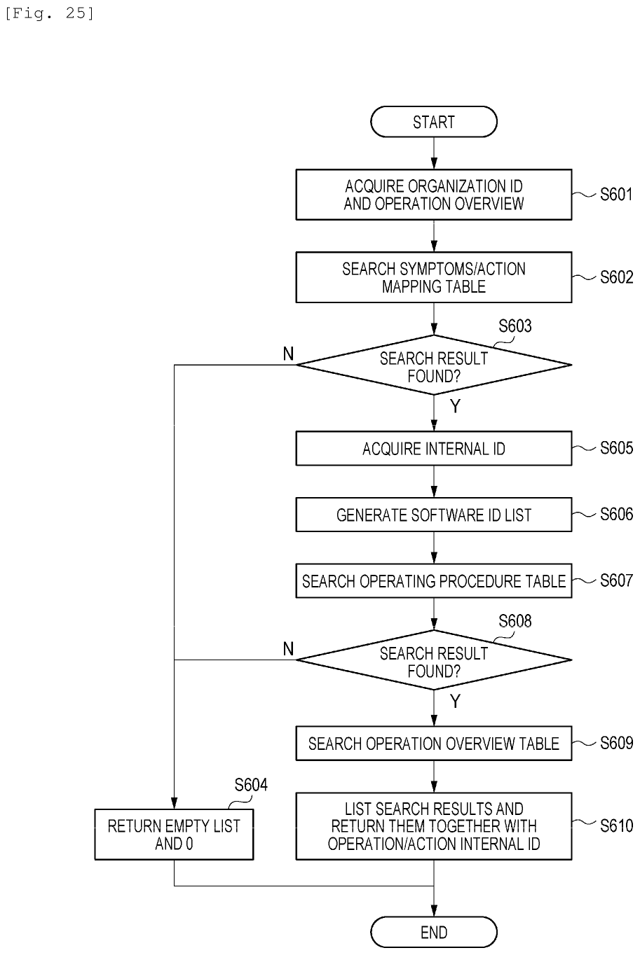

FIG. 24 illustrates an example of a screen displayed by the operating procedure presentation processing of the second embodiment. A difference from the operating procedure display screen 1901 of the first embodiment is an area 2402 displaying a high-similarity operating procedures list based on the classification as a result of the machine learning. The number of operating procedures displayed on the area 2402 displaying the high-similarity operating procedures list corresponds to the number of operation overviews output (as a character string with serial numbers added to “high-similarity operation procedures” in the present embodiment) as a result of the procedure identification processing 2103.

When the maintenance SE 27 selects any of the operating procedures in the area 2402, the operating procedure corresponding to the operating procedure display area 1905 is displayed. When the maintenance SE 27 presses the success button 1910, the processor 21 adds, as new learning data, the operating procedures of the actual operation by the maintenance SE 27 to the operating procedure learning table 2201 together with the operation/action internal ID obtained from the procedure identification processing.

On the other hand, when the maintenance SE 27 presses the fail button 1911 or closes the operating procedure presentation screen 2401 without pressing the success button 1910, the processor 21 inserts a new row, in the symptoms/action mapping table 2210, with the value of the organization ID 2212 stored as the organization ID 2212, a character string indicating the target and the symptoms/action acquired from the operation overview display field 1902 stored as the target 2213 and the symptoms/action 2214, and a numerical value that is different from the existing numerical values of the internal ID stored as the internal ID 2115. Furthermore, the operating procedures of the actual operation by the maintenance SE 27 are added, to the operating procedure learning table 2201, as the new learning data together with the value of the internal ID previously used.

FIG. 25 illustrates a processing flow of the procedure identification processing 2103. First of all, in the procedure identification processing 2103, the values of the organization ID of the organization to which the maintenance SE 27 that has started the operating procedure presentation screen 2401 belongs, and of the operation overview display field are acquired (step S601). Next, the symptoms/action mapping table 2210 is searched for a row with the matching value of the organization ID 2212 and the values of the target 2213 and the symptoms/action 2214 included in the values of the operation overview display field (step S602). Whether the search result is found is identified (step S603). When the search result is not found, a value (empty list and 0 in the present embodiment) indicating the absence of the procedure is returned, and the processing ends (step S604). When the search result is found, the value of the internal ID 2215 is acquired (S605).

Next, in the procedure identification processing 2103, the software mapping table 406 is searched for a row with the value of the organization ID 52 matching the organization ID acquired in step S601, and a combination list of the values of the ID 51 is internally held (step S606). Then, the operating procedure learning table 2201 is searched for a row with the matching operation/action internal ID 2203, and with the software ID group entirely included in the ID list generated in step S606 (step S607). Whether the search result is found is identified (step S608), and the processing proceeds to step S604 when the search result is not found.

When the search result is found, in the procedure identification processing 2103, the operation overview table 412 is searched for data with the value of the organization ID 1202 matching the organization ID used in step S606, and with the operation overview 1203 including the values of the target 2213 and the symptoms/action 2214 in the row of search result for in step S602. For other organization IDs, data including a character string as a result of converting the target and the symptoms/action into dialects of each organization is searched for using the symptoms/action mapping table 2210 (step S609). Then, data in which the IDs are listed based on the search result and the operation/action internal ID are returned, and the processing ends (step S610).

With the operating procedures for a plurality of organizations accumulated in the past thus classified using the machine learning and with the accuracy of the classification improved based on the feedback from the maintenance SE, the operating procedures are more efficiently shared.

Even though the same type of operation is performed in a plurality of environments, the operating procedures have not been shared actively, because operation procedures are not guaranteed to work in different environments with different software combinations and because it is difficult to determine whether the same type of operation can be performed in different organizations due to use of different terms. In view of this, the embodiments described above provide a technique enabling operating procedures to be shared among different organizations/environments.

According to the present disclosure, an operating procedure presentation device or the like is provided that aggregates operating procedure data collected from each environment, by generating a mapping table for software installed in each environment, a mapping table of an operation, and a term table related to failure and operation used in each environment and internally classifying similar operations, and presents a procedure in another environment together with an environment similarity when the same failure or management operation occurs.

The present invention is not limited to the embodiments described above, and includes various modifications. For example, the embodiments are described in detail for easy understanding of the present invention, and are not necessarily limited to such examples that include all the configurations described. In addition, part of the configuration of an embodiment can be replaced with the configuration of another embodiment, and a configuration of an embodiment is added to the configuration of another embodiment. For part of the configuration of each embodiment, addition, deletion, and replacement with another configuration can be made.

In the example described above, the operating procedure presentation device presents an operation content including the order 1906. Alternatively, for example, displaying may be performed with the order 1906 omitted.

The operating procedure presentation device (24a, 24b) may be configured as a server, and an operating procedure presentation system (operation content presentation system) may be configured that outputs the operating procedure presentation screen (1901, 2401) to a terminal used by the maintenance SE 27 onsite. The terminal is configured as appropriate and can be configured using a personal computer for example. In addition, the terminal may be configured using a tablet.

### REFERENCE SIGNS LIST

24 (a, b): operating procedure presentation device
32: main memory
33: storage device
401: operation data collection processing
402: operation commonization processing
403: similarity calculation processing
404: host acquisition processing
405: operating procedure presentation processing
406: software mapping table
407: operation mapping table
408: dialect mapping table
409: operation target table
410: data source table
411: operation data table
412: operation overview table
413: commonization operation table
414: operation recommendation level table

1. An operation content presentation method performed using a processor, a storage device, and a display device, characterized in that:
the storage device stores a software mapping table storing information on software used by each of organizations, an operation mapping table storing information on an operation of a same content for a predetermined operation, and an operation target table listing operation targets of the respective organizations;
the processor performs commonization of an operation content corresponding to a response content among the organizations, using the software mapping table, the operation mapping table, and the operation target table; and
the processor makes the display device display, using a response content of a predetermined one of the organizations as an input, an operation content of another one of the organizations similar to the operation content corresponding to the response content.

2. The operation content presentation method according to claim 1, characterized in that the operation content includes information on operating procedures.

3. The operation content presentation method according to claim 1, characterized in that
the storage device stores a term mapping table listing terms used in each of the organizations,
the processor calculates a similarity with an environment of another one of the organizations, using the software mapping table and the term mapping table, with a response content used term of which is different among the organizations being an input, and
the processor makes the display device display information on the similarity.

4. The operation content presentation method according to claim 3, characterized in that the processor calculates the similarity based on any one of number of matching software types, number of matching software names, and number of matching software names and versions.

5. The operation content presentation method according to claim 1, characterized in that:
the processor calculates a recommendation level of the operation content based on a record of success or fail of the operation content displayed, and
the processor makes the display device display information on the recommendation level.

6. The operation content presentation method according to claim 3, characterized in that:
the processor calculates, based on a record of success or fail of an operation content displayed, the recommendation level of the operation content through addition or subtraction of a value based on the similarity, and
the processor makes the display device display information on the recommendation level.

7. An operation content presentation device comprising:
a processor; and
a storage device, characterized in that
the storage device stores
a software mapping table storing information on software used by each of organizations,
an operation mapping table storing information on an operation of a same content for a predetermined operation, and
an operation target table listing operation targets of the respective organizations, and
the processor
performs commonization of an operation content corresponding to a response content among the organizations, using the software mapping table, the operation mapping table, and the operation target table, and
outputs, using a response content of a predetermined one of the organizations as an input, an operation content of another one of the organizations similar to the operation content corresponding to the response content.

8. The operation content presentation device according to claim 7, characterized in that the operation content includes information on operating procedures.

9. The operation content presentation device according to claim 7, characterized in that
the storage device stores a term mapping table listing terms used in each of the organizations, and
the processor calculates a similarity with an environment of another one of the organizations, using the software mapping table and the term mapping table, with a response content used term of which is different among the organizations being an input, and outputs the similarity.

10. The operation content presentation device according to claim 9, characterized in that the processor calculates the similarity based on any one of number of matching software types, number of matching software names, and number of matching software names and versions.

11. The operation content presentation device according to claim 7, characterized in that
the processor
calculates a recommendation level of the operation content based on a record of success or fail of the operation content displayed, and
outputs the recommendation level.

12. The operation content presentation device according to claim 9, characterized in that
the processor
calculates based on a record of success or fail of an operation content, the recommendation level of the operation content through addition or subtraction of a value based on the similarity, and
outputs the recommendation level.

13. An operation content presentation system characterized by comprising:
the operation content presentation device according to claim 7; and
a terminal to which the operation content presentation device outputs the operation content.

14. An operation content presentation device comprising a processor, characterized in that
the processor
classifies an actual operation target and operation content through machine learning, with a response content used term of which is different among organizations being an input, and
outputs an operation content expected to correspond to a response content and a software configuration of another organization.

15. An operation content presentation system characterized by comprising:
the operation content presentation device according to claim 14; and
a terminal to which the operation content presentation device outputs the operation content.
